(19) United States
(12) Patent Application Publication
(10) Pub. No.: US 2016/0070054 A1
(43) Pub. Date: Mar. 10, 2016

(54) LIGHT GUIDE AND MANUFACTURING METHOD OF SAME

(71) Applicant: HON HAI PRECISION INDUSTRY CO., LTD., New Taipei (TW)

(72) Inventors: CHAU-JIN HU, Tu-Cheng (TW); FENG-YUEN DAI, New Taipei (TW); KUN-CHAN WU, Tu-Cheng (TW); JIA-MING WANG, Tu-Cheng (TW)

(21) Appl. No.: 14/687,680

(22) Filed: Apr. 15, 2015

(30) Foreign Application Priority Data
Sep. 9, 2014 (TW) 103131057

(51) Int. Cl. F21V 8/00

(52) U.S. Cl. CPC G02B 6/0065; G02B 6/0055; G02B 6/0036

(57) ABSTRACT

A light guide includes a guiding layer and a reflecting layer. The guiding layer includes a light emitting surface and a bottom surface opposite to the light emitting surface. The reflecting layer is formed on the bottom surface. The reflecting layer is a compound containing polyester polyols, isocyanic aci, butyl acetate and reflective powder, or a compound containing curing agents and reflective powder.

### FIELD

The subject matter herein generally relates to display technology, particularly to a light guide and a manufacturing method of the light guide for a display.

### BACKGROUND

A backlight module usually includes a light guide and a reflecting piece separated from the light guide, which makes the backlight module big.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagrammatic, front view of a light guide according to a first embodiment of the present disclosure.

FIG. 2 is a flow chart of a manufacturing method of a light guide according to a second embodiment of the present disclosure.

FIG. 3 is a flow chart of a manufacturing method of a light guide according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a light guide.

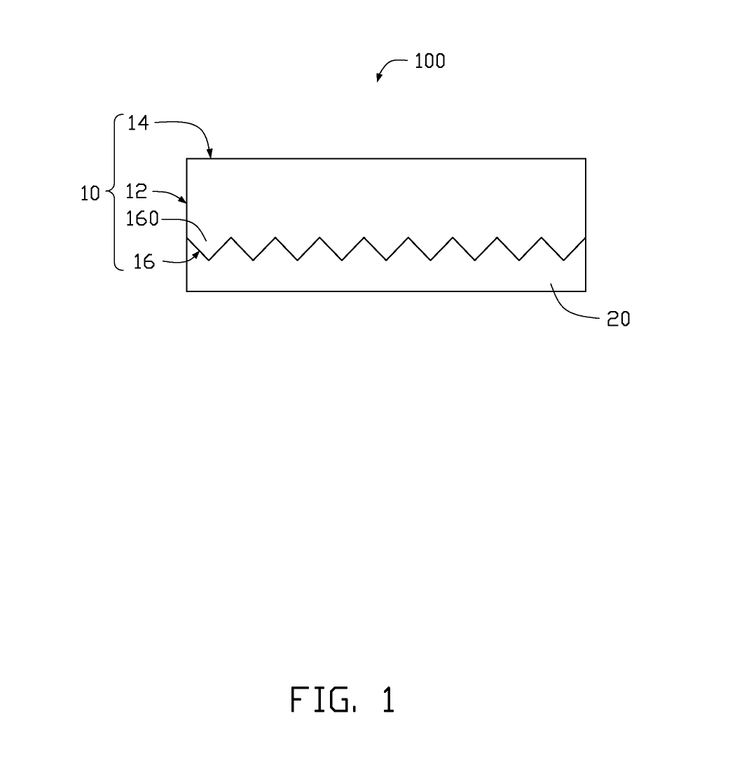

FIG. 1 shows a light guide 100 according to a first embodiment of the present disclosure. The light guide 100 includes a guiding layer 10 and a reflecting layer 20.

The guiding layer 10 includes a light incident surface 12, a light emitting surface 14 and a bottom surface 16. The light emitting surface 14 is opposite to the bottom surface 16. The light incident surface 12 is interconnected between the light emitting surface 14 and the bottom surface 16. In this embodiment, a plurality of micro-structures 160 is formed on the bottom surface 16. In other embodiments, the bottom surface 16 can be a plate surface and has no micro-structure. The guiding layer 10 is made of polymethyl methacrylate (PMMA) or polycarbonate (PC).

The reflecting layer 20 is formed on the bottom surface 16 and covers the whole bottom surface 16. In this embodiment, the reflecting layer 20 covers the plurality of micro-structures 160.

The reflecting layer 20 is a compound containing polyester polyols, isocyanic aci, butyl acetate and reflective powder or a compound containing curing agents and reflective powder. The curing agents include acrylic monomer, polyurethane acrylate oligomer, polyester acrylic modified polyester oligomer, and photo initiator.

When the reflecting layer 20 is the compound containing polyester polyols, isocyanic aci, butyl acetate and reflective powder, a weight percentage between the sum of the polyester polyols and the isocyanic aci, the butyl acetate, and the reflective powder is 15%-30%:50%:20%-35%. A particle size of the reflective powder is in a range from 0.2 micrometer (um) to 0.3 um, preferably 0.2 um.

When the reflecting layer 20 is the compound containing curing agents and reflective powder. A weight percentage between the curing agents and the reflective powder is 80%:20%, 72%:28%, 70%:30%, or 65%:35%. In the curing agents, a weight percentage between the acrylic monomer, the polyurethane acrylate oligomer, the polyester acrylic modified polyester oligomer and the photo initiator 50%:30%:15%:5%. In this embodiment, the acrylic monomer is isobornyl methacrylate, the polyurethane acrylate oligomer is aliphatic urethane acrylate, the polyester acrylic modified polyester oligomer is carboxylated polyester acrylate, and the photo initiator is hydroxycyclohexyl-phenyl-ketone.

In this embodiment, the reflective powder is white. The reflective powder is barium sulfate or titanium pigment, preferably titanium pigment.

The present disclosure relates to a first manufacturing method of the light guide.

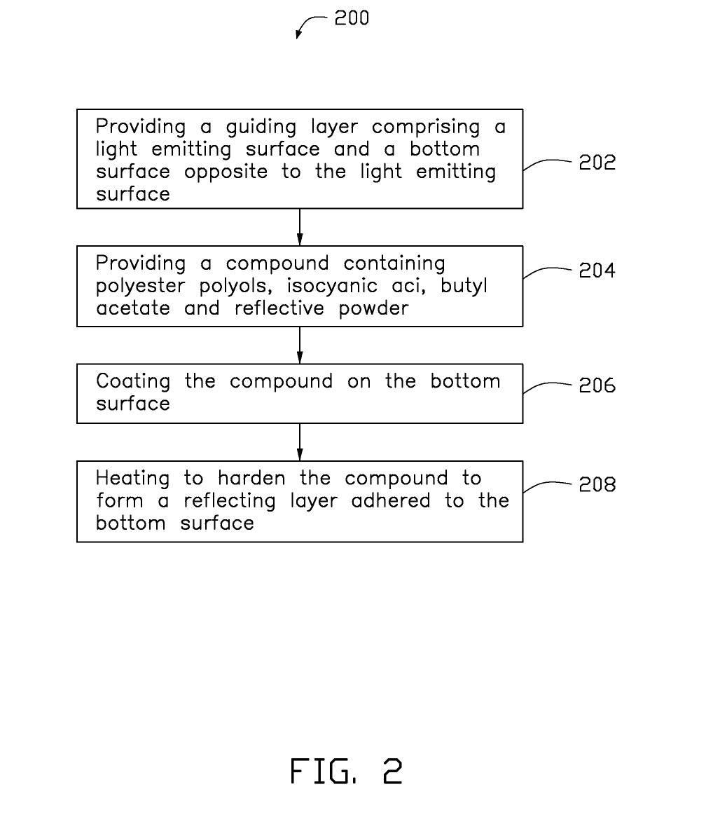

Referring to FIG. 2, a flowchart is presented in accordance with an example embodiment which is being thus illustrated. An example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the example method 200. Furthermore, the illustrated order of blocks is by example only and the order of the blocks can change according to the present disclosure. Additional blocks may be added or fewer blocks may be utilized, without departing from this disclosure. The example method 200 can begin at block 202.

At block 202, a guiding layer 10 is provided. The guiding layer 10 can be made by embossing or injection.

At block 204, a compound containing polyester polyols, isocyanic aci, butyl acetate and reflective powder is provided. A weight percentage between the sum of the polyester polyols and the isocyanic aci, the butyl acetate, and the reflective powder is 15%-30%:50%:20%-35%. A particle size of the reflective powder is in a range from 0.2 micrometer (um) to 0.3 um. Preferably, a weight percentage of the sum of the polyester polyols and the isocyanic aci to the compound is 15%, a weight percentage of the reflective powder to the compound is 35%, and the particle size of the reflective powder is 0.2 um.

At block 206, the compound is coated on the bottom surface 16 of the guiding layer 10.

At block 208, the compound is heated and hardened to form the reflecting layer 20. In this embodiment, the reflecting layer 20 covers the micro-structures 160. The compound is heated by infrared light or by a roaster.

It is proved by testing that when the weight percentage between the sum of the polyester polyols and the isocyanic aci, the butyl acetate, and the reflective powder is 15%-30%:50%:20%-35%, the reflecting layer 20 can be adhered to the guiding layer 10 firmly, and when the weight percentage between the sum of the polyester polyols and the isocyanic aci, the butyl acetate, and the reflective powder is 15%:50%:35%, the reflecting layer 20 has a best reflecting effect.

The present disclosure relates to a second manufacturing method of the light guide.

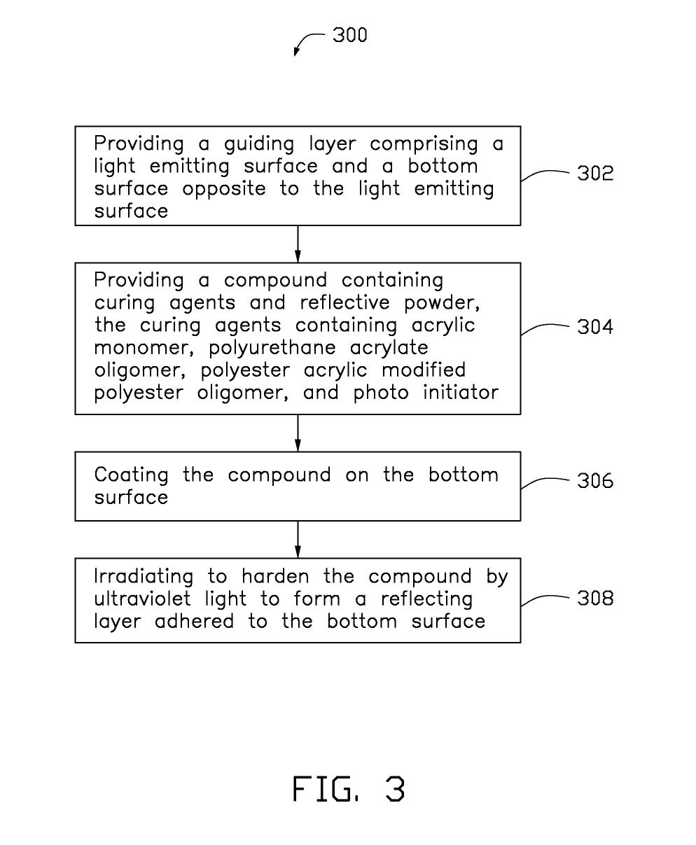

Referring to FIG. 3, a flowchart is presented in accordance with an example embodiment which is being thus illustrated. An example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods or subroutines, carried out in the example method 300. Furthermore, the illustrated order of blocks is by example only and the order of the blocks can change according to the present disclosure. Additional blocks may be added or fewer blocks may be utilized, without departing from this disclosure. The example method 300 can begin at block 302.

At block 302, a guiding layer 10 is provided. The guiding layer 10 can be made by embossing or injection.

At block 304, a compound containing curing agents and reflective powder. A weight percentage between the curing agents and the reflective powder is 80%:20%, 72%:28%, 70%:30%, or 65%:35%. In the curing agents, a weight percentage between the acrylic monomer, the polyurethane acrylate oligomer, the polyester acrylic modified polyester oligomer, and the photo initiator is 50%:30%:15%:5%. In this embodiment, the acrylic monomer is isobornyl methacrylate, the polyurethane acrylate oligomer is aliphatic urethane acrylate, the polyester acrylic modified polyester oligomer is carboxylated polyester acrylate, and the photo initiator is hydroxycyclohexyl-phenyl-ketone.

At block 306, the compound is coated on the bottom surface 16 of the guiding layer 10.

At block 308, the compound is irradiated by ultraviolet light (UV light) and hardened to form the reflecting layer 20. In this embodiment, the reflecting layer 20 covers the micro-structures 160. A wavelength of the UV light is in a range from 320 nanometers (nm) to 400 nm, an intensity of the UV light is 3660.834 milli-watt per square centimeter (mW/cm̂2), and a lasting time of the UV light is 1.35 second (s).

It is proved by testing that when the weight percentage between the curing agents and the reflective powder is 80%:20%, 72%:28%, 70%:30%, or 65%:35%, the reflecting layer 20 can be adhered to the guiding layer 10 firmly, and the reflecting layer 20 has a good reflecting effect.

The light guide 100 integrates a guiding layer 10 and a reflecting layer 20. Thus, a backlight module including the light guide 100 needs no independent reflecting piece and can be thin.

It will be understood that the above particular embodiments are shown and described by way of illustration only. The principles and the features of the present disclosure can be employed in various and numerous embodiments thereof without departing from the scope of the disclosure. The above-described embodiments illustrate the scope of the disclosure but do not restrict the scope of the disclosure.

What is claimed is:

1. A light guide comprising:
a guiding layer having a light emitting surface, a bottom side opposite the light emitting surface and a light incident surface connecting the light emitting surface with bottom side; and
a reflective layer formed on the bottom side of the guiding layer;
wherein, the reflecting layer contains polyester polyols, isocyanic aci, butyl acetate and reflective powder.

2. The light guide of claim 1, wherein, weight percentages in the reflective layer is substantially 15%-30% polyester polyols and isocyanic aci; 50% butyl acetate; and 20%-35% reflective powder.

3. The light guide of claim 2, wherein, the weight percentages in the reflective layer is substantially 15% polyester polyols and isocyanic aci; 50% butyl acetate; and 35% reflective powder.

4. The light guide of claim 1, further comprising a plurality of micro-structures formed on the bottom surface and covered by the reflecting layer.

5. A light guide comprising:
a guiding layer having a light emitting surface, a bottom side opposite the light emitting surface and a light incident surface connecting the light emitting surface with bottom side; and
a reflective layer formed on the bottom side of the guiding layer;
wherein, the reflecting layer contains one or more curing agents and reflective powder.

6. The light guide of claim 5, wherein the one or more curing agents contains acrylic monomer, poly acrylate oligomer, polyester acrylic modified polyester oligomer and a photo initiator.

7. The light guide of claim 6, wherein weight percentages in the one or more curing agents is substantially 50% acrylic monomer, 30% polyurethane acrylate oligomer, 15% polyester acrylic modified polyester oligomer, and 5% photo initiator.

8. The light guide of claim 5, wherein weight percentages in the reflecting layer is substantially 80% curing agents and 20% reflective power; or 72% curing agents and 28% reflective power; or 70% curing agents and 30% reflective power; or 65% curing agents and 35% reflective power.

9. The light guide of claim 5, further comprising a plurality of micro-structures formed on the bottom surface and covered by the reflecting layer.

10. A manufacturing method of a light guide, comprising steps of:
providing a guiding layer comprising a light emitting surface and a bottom surface opposite to the light emitting surface;
providing a compound containing polyester polyols, isocyanic aci, butyl acetate and reflective powder;
coating the compound on the bottom surface; and
heating to harden the compound to form a reflecting layer adhered to the bottom surface.

11. The manufacturing method of claim 10, wherein the bottom surface comprising micro-structures covered by the reflecting layer.

12. The manufacturing method of claim 10, wherein a weight percentage between the sum of the polyester polyols and the isocyanic aci, the butyl acetate, and the reflective powder is 15%-30%:50%:20%-35%.

13. The manufacturing method of claim 12, wherein a weight percentage between the sum of the polyester polyols and the isocyanic aci, the butyl acetate, and the reflective powder is 15%:50%:35%.

14. A manufacturing method of a light guide, comprising steps of:
providing a guiding layer comprising a light emitting surface and a bottom surface opposite to the light emitting surface;
providing a compound containing curing agents and reflective powder, the curing agents containing acrylic monomer, polyurethane acrylate oligomer, polyester acrylic modified polyester oligomer, and photo initiator;
coating the compound on the bottom surface; and
irradiating to harden the compound by ultraviolet light to form a reflecting layer adhered to the bottom surface.

15. The manufacturing method of claim 14, wherein the bottom surface comprising micro-structures covered by the reflecting layer.

16. The manufacturing method of claim 14, wherein a weight percentage between the curing agents and the reflective powder is 80%:20%, 72%:28%, 70%:30%, or 65%:35%.

17. The manufacturing method of claim 14, wherein a weight percentage between the acrylic monomer, the polyurethane acrylate oligomer, the polyester acrylic modified polyester oligomer, and the photo initiator is 50%:30%:15%:5%.
